(19) United States
(12) Patent Application Publication
(10) Pub. No.: US 2015/0013218 A1
(43) Pub. Date: Jan. 15, 2015

(54) Fence and Post Barrier

(71) Applicant: Mark Wanta, Rudolph, WI (US)

(72) Inventor: Mark Wanta, Rudolph, WI (US)

(21) Appl. No.: 13/938,451

(22) Filed: Jul. 10, 2013

(51) Int. Cl. A01G 1/08

(52) U.S. Cl. CPC A01G 1/08
USPC 47/33

(57) ABSTRACT

A fence post base featuring a circumferential disc that provides a larger ground coverage area than that of the fence post itself is disclosed. The disc prevents weeds and grass from growing immediately adjacent to the fence post by cutting off sunlight to the relevant area of ground. Since the expanded disc sits at or immediately above the ground, it may be ridden over by a standard lawnmower, allowing the mower's cutting parts to reach all areas of grass and weeds without the need for an edging mower or clipper. The device may be made for a variety of fence posts and may feature a slit to all for the device to expand and contract in extreme temperatures without breaking.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The invention relates generally to the field of fence posts and particularly to the field of devices for keeping weeds and grass from growing up against fence posts. The problem of cutting grass and weeds immediately adjacent to vertical structures has long vexed gardeners and landscapers. Typically, in order to keep a clean look next to a fence post, the landscaper or gardener must use an edging mower or clipper to do fine cutting (undesirable because it is time consuming), or must resort to chemical weed killers (undesirable because they can be toxic to children and animals and may harm the environment). A better approach is to use a device that expands the ground coverage area of the fence post to prevent weeds and grass from growing immediately adjacent to the post by cutting off sunlight from the relevant area.

### SUMMARY OF THE INVENTION

Accordingly, the invention is directed to a fence post base that features a circumferential disc that provides a larger ground coverage area than that of the fence post itself. The disc prevents weeds and grass from growing immediately adjacent to the fence post by cutting off sunlight to the relevant area of ground. Since the expanded disc sits at or immediately above the ground, it may be ridden over by a standard lawnmower, allowing the mower's cutting parts to reach all areas of grass and weeds without the need for an edging mower or clipper. The device may be made for a variety of fence posts and may feature a slit to all for the device to expand and contract in extreme temperatures without breaking.

Additional features and advantages of the invention will be set forth in the description which follows, and will be apparent from the description, or may be learned by practice of the invention. The foregoing general description and the following detailed description are exemplary and explanatory and are intended to provide further explanation of the invention.

### BRIEF DESCRIPTION OF THE DRAWINGS

The accompanying drawings are included to provide a further understanding of the invention and are incorporated into and constitute a part of the specification. They illustrate several exemplary embodiments of the invention and, together with the description, serve to explain the principles of the invention.

FIG. 1 shows a front view of a rectangular-post fence having the first exemplary embodiment of the invention installed thereon, showing the fence 10, rectangular post 11, base 12, and expanded rim 13.

FIG. 2 shows a top view of the first exemplary embodiment of the invention, showing the opening 20, lip 21, and rim 22.

FIG. 3 shows a top view of the second exemplary embodiment of the invention, showing the opening 30, lip 31, rim 32, and slit 33.

FIG. 4 shows a top view of the third exemplary embodiment of the invention, showing the opening 40, lip 41, rim 42, and notch 43.

FIG. 5 shows a front view of a T-post fence having the fourth exemplary embodiment of the invention installed thereon, showing the fence 50, T-post 51, base 52, and rim 53.

FIG. 6 shows a top view of the fourth exemplary embodiment of the invention, showing the T-shaped opening 60, lip 61, and rim 62.

FIG. 7 shows a top view of the fifth exemplary embodiment of the invention, showing the T-shaped opening 70, lip 71, rim 72m, and slit 73.

FIG. 8 shows a top view of the sixth exemplary embodiment of the invention, showing the T-shaped opening 80, lip 81, rim 82, and notch 83.

### DETAILED DESCRIPTION OF THE INVENTION

Referring now to the invention in more detail, FIGS. 1-2 depict the first exemplary embodiment of the invention. In FIG. 1, the first exemplary embodiment of the invention is installed on a fence 10 having one or more rectangular posts 11. The rectangular post is set into a base 12 that features an expanded rim 13. The base 12 is made of a material that is impervious to water and optically opaque. To protect the post 11, the base 12 should fit snugly. The base 12 and rim 13 should be a made of a material that is durable, tends to bend rather than crack, and resists photo-degradation. Many known plastic, metal, ceramic and other materials exhibit combinations of these properties and any may be used effectively.

FIG. 2 shows the first exemplary embodiment. In the first exemplary embodiment, an opening 20 is provided that is fully surrounded by a lip 21, which in turn is fully surrounded by a rim 22. The opening 20 is square or rectangular to fit a square or rectangular post. The first exemplary embodiment provides maximum coverage around the post but does not allow for the device to flex in response to variations in post size or changes in temperature. The lip 21 is preferably tall relative to the height of the rim 22, and this is so for all of the embodiments described herein. The rim 22 is preferably a disc, but may be of any shape having a top surface and a bottom surface that have a large surface area relative to one or more sides, and this is so for all of the embodiments described herein. The rim 22 is preferably symmetrical about an axial line orthogonal to the top and bottom surfaces, and the lip 21 and opening 20 are similarly aligned to the axial line; this is so for all of the embodiments described herein. The opening 20 preferably penetrates entirely through the rim 22 and lip 21.

FIG. 3 shows the second exemplary embodiment of the invention. In the second exemplary embodiment, an opening 30 is provided that is surrounded by a lip 31 and rim 32. The opening 30 is square or rectangular to fit a square or rectangular post. A slit 33 penetrates the lip 31 and rim 32 to reach the opening 30 and serves to prevent breakage as the post holder expands and contracts in response to changes in temperature, and also to accommodate some variance in the size of posts that fit.

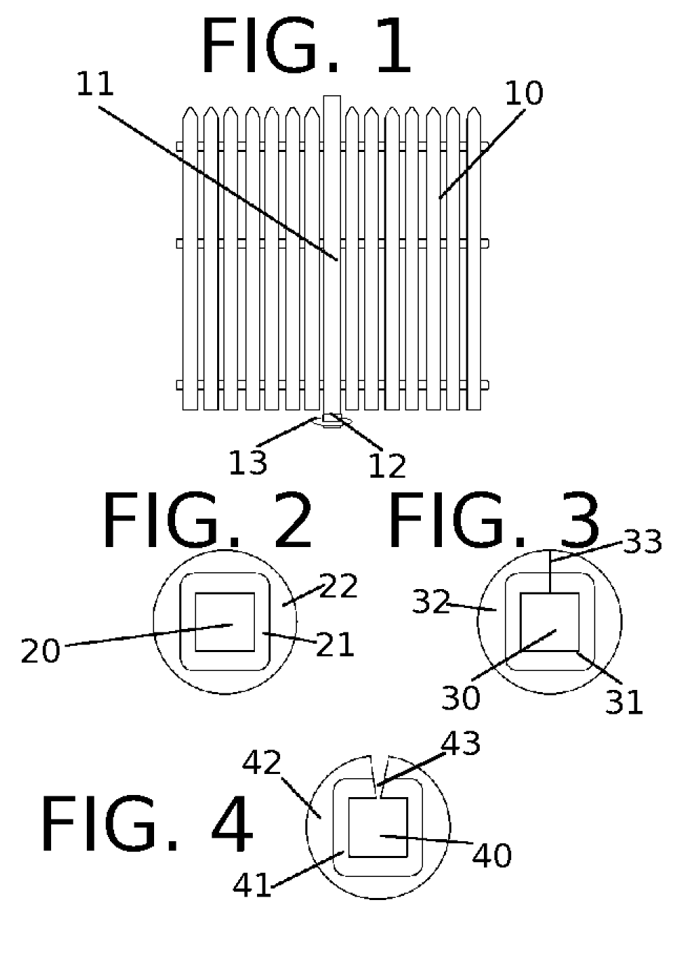

FIG. 4 shows the third exemplary embodiment of the invention. In the third exemplary embodiment, an opening 40 is provided that is surrounded by a lip 41 and rim 42. The opening 40 is square or rectangular to fit a square or rectangular post. A notch 43 penetrates the lip 41 and rim 42 to reach the opening 40 and serves to prevent breakage as the post holder expands and contracts in response to changes in temperature, and also to accommodate some variance in the size of posts that fit.

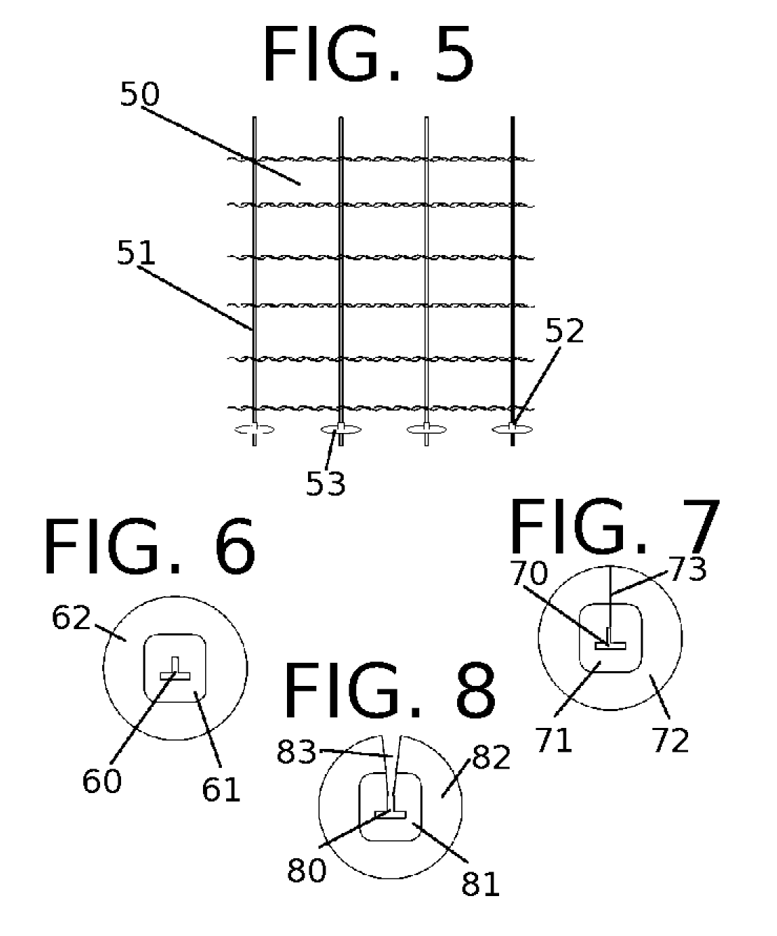

FIGS. 5-6 depict the fourth exemplary embodiment of the invention. In FIG. 5, the fourth exemplary embodiment of the invention is installed on a fence 50 having one or more T-posts 51. Each T-post 51 is set into a base 52 that features an expanded rim 53. The base 52, as in the preciously discussed embodiments, is made of a material that is impervious to water and optically opaque. To protect the post 51, the base 52 should fit snugly. The base 52 and rim 53 should be a made of a material that is durable, tends to bend rather than crack, and resists photo-degradation. Many known plastic, metal, ceramic and other materials exhibit combinations of these properties and any may be used effectively.

FIG. 6 shows the fourth exemplary embodiment. In the fourth exemplary embodiment, an opening 60 is provided that is fully surrounded by a lip 61, which in turn is fully surrounded by a rim 62. The opening 60 is T-shaped to fit a T-post. This embodiment provides maximum coverage around the post but does not allow for the device to flex in response to extreme temperatures.

FIG. 7 shows the fifth exemplary embodiment of the invention. In fifth exemplary embodiment, an opening 70 is provided that is surrounded by a lip 71 and rim 72. The opening 70 is T-shaped to fit a T-post. A slit 73 penetrates the lip 71 and rim 72 to reach the opening 30 and serves to prevent breakage as the post holder expands and contracts in response to changes in temperature, and also to accommodate some variance in the size of posts that fit.

FIG. 8 shows the sixth exemplary embodiment of the invention. In the sixth exemplary embodiment, an opening 80 is provided that is surrounded by a lip 81 and rim 82. The opening 80 is T-shaped to fit a T-post. A notch 83 penetrates the lip 81 and rim 82 to reach the opening 40 and serves to prevent breakage as the post holder expands and contracts in response to changes in temperature, and also to accommodate some variance in the size of posts that fit.

While the foregoing written description of the invention enables one of ordinary skill to make and use what is presently considered to be the best mode thereof, those of ordinary skill in the art will understand and appreciate the existence of variations, combinations, and equivalents of the specific embodiment, method, and examples herein. The invention should, therefore, not be limited by the above described embodiment, method, and examples, but by all embodiments and methods within the scope and spirit of the invention.

I claim:

1. A vegetation barrier comprising:
(a) an opening;
(b) a lip;
(c) a rim;
(d) said rim having a top surface and a bottom surface, defining an axial line orthogonal to both said top surface and said bottom surface;
(e) said opening being located in the center of said rim and aligned with the axial line of said rim;
(f) said lip being affixed about the outer edge of said opening;
whereby a fence post may be placed within said opening and driven into the ground such that said rim will block light and air to the earth immediately around said fence post, thereby preventing vegetation growth in the covered area.

2. The vegetation barrier of claim 1 wherein said opening is about square in shape, whereby a square fence post may be accommodated.

3. The vegetation barrier of claim 1 wherein said opening is T-shaped, whereby a T-shaped fence post may be accommodated.

4. The vegetation barrier of claim 1 wherein said rim fully surrounds said opening.

5. The vegetation barrier of claim 1 wherein a slit penetrates said rim radially from the outer edge of said rim to said opening.

6. The vegetation barrier of claim 1 wherein a notch penetrates said rim radially from the outer edge of said rim to said opening.

7. The vegetation barrier of claim 2 wherein said rim fully surrounds said opening.

8. The vegetation barrier of claim 2 wherein a slit penetrates said rim radially from the outer edge of said rim to said opening.

9. The vegetation barrier of claim 2 wherein a notch penetrates said rim radially from the outer edge of said rim to said opening.

10. The vegetation barrier of claim 3 wherein said rim fully surrounds said opening.

11. The vegetation barrier of claim 3 wherein a slit penetrates said rim radially from the outer edge of said rim to said opening.

12. The vegetation barrier of claim 3 wherein a notch penetrates said rim radially from the outer edge of said rim to said opening.

13. The vegetation barrier of claim 1 wherein said rim and said lip are optically opaque.

14. The vegetation barrier of claim 2 wherein said rim and said lip are optically opaque.

15. The vegetation barrier of claim 3 wherein said rim and said lip are optically opaque.
